(19) United States
(12) Patent Application Publication
(10) Pub. No.: US 2024/0017274 A1
(43) Pub. Date: Jan. 18, 2024

(54) CENTRIFUGE ROTOR

(71) Applicant: THE KIT COMPANY, INC., San Francisco, CA (US)

(72) Inventors: Qiao LIANG, San Francisco, CA (US); Philip FUNG, San Francisco, CA (US)

(21) Appl. No.: 18/222,438

(22) Filed: Jul. 15, 2023

Related U.S. Application Data
(60) Provisional application No. 63/389,821, filed on Jul. 15, 2022.

(51) Int. Cl. B04B 5/04

(52) U.S. Cl. CPC B04B 5/0414

(57) ABSTRACT

A centrifuge rotor includes tube retainers for holding two or more sample tubes at a 90 degree angle in a minimized configuration for effective separation of a blood sample using a mini centrifuge. The centrifuge rotor with sample tubes in place has an overall width that is less than two times the length of a sample tube.

### CROSS-REFERENCE TO RELATED APPLICATIONS

The present application claims the benefit of U.S. Provisional Application 63/389,821, filed on Jul. 15, 2022, which is incorporated herein by reference in its entirety.

### FIELD

The present disclosure relates to the field of centrifuge rotors. More particularly, the present disclosure relates to a compact centrifuge rotor design arranged to reduce width, volume, and weight and capable of effectively separating biological fluid samples.

### BACKGROUND

Accurate analysis of a blood sample obtained from a subject requires that the plasma and red blood cells (RBCs) of the blood sample are separated from the time of collection to analysis. Mixing of the red blood cells and plasma increases lysis of the red blood cells (i.e., hemolysis), thereby rendering RBC analysis of the blood sample inaccurate and possibly ineffective. Accordingly, effective separation of the blood sample upon collection is imperative. Centrifuges have been used for several hundred years to separate components in a sample based on the density of the components. Centrifuges for separating biological samples such as blood are known in the art. Currently, there are two primary types of centrifuges on the market, one of which has a fixed angle rotor (typically less than 45 degrees), and the other of which has a swing bucket rotor (at approximately 90 degrees when spinning at full speed). While the fixed angle rotor is compact, the resulting separation from a 45 degree tube angle renders an increase in the risk of red blood cells leaking into the separated serum. A swing bucket rotor can provide effective blood separation; however, both the design of the swing bucket rotor and the power requirement to produce the 90 degree rotation, requires a larger sized rotor for use in a high powered centrifuge, all of which results in higher cost and could not be easily transported.

It is desirable to provide a compact centrifuge rotor for use in a compact, portable centrifuge for effectively separating biological (e.g., blood) samples.

### SUMMARY

In one embodiment, a centrifuge and tube assembly includes a centrifuge body and a centrifuge rotor that rotates with respect to the centrifuge body about a rotation axis. The centrifuge rotor includes a rotor body and a plurality of tube retainers. The tube retainers are configured to receive a plurality of tubes, with each of the plurality of tubes having a tube length. The plurality of tubes are positioned side-by-side and overlap at the rotation axis. The centrifuge rotor having tube retainers with sample tubes positioned therein, has an overall width that is less than twice the length of the sample tube.

Aspects of embodiments of the present invention also include a kit for remote collection of a blood sample, wherein the kit comprises a compact centrifuge rotor as disclosed herein for use with a lightweight mini centrifuge. In some embodiments, the kit includes the compact centrifuge rotor and at least two sample tubes. In other embodiments, the kit includes the compact centrifuge rotor, at least two sample tubes, and a mini portable centrifuge.

### BRIEF DESCRIPTION OF THE DRAWINGS

In the accompanying drawings, structures are illustrated that, together with the Detailed Description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1A is a perspective view of one embodiment of a fixed angle centrifuge rotor.

FIG. 1B is a perspective view of the fixed angle centrifuge rotor holding a pair of tubes.

FIG. 2 is an exemplary tube.

FIG. 3 is a front view of the fixed angle centrifuge rotor.

FIG. 4 is a ide view of the fixed angle centrifuge rotor.

FIG. 5 is a top view of the fixed angle centrifuge rotor.

FIG. 6A is a perspective view of an alternative embodiment of a fixed angle centrifuge device.

FIG. 6B is a perspective view of the fixed angle centrifuge device of FIG. 6A holding a pair of tubes.

FIG. 7 is a top view of an embodiment of a centrifuge rotor.

FIG. 8 is a front view of the centrifuge rotor shown in FIG. 7.

FIG. 9 is a side view of the centrifuge rotor shown in FIG. 7.

FIG. 10 is a top view of another alternative embodiment of a centrifuge rotor.

FIG. 11 is a front view of the centrifuge rotor shown in FIG. 10.

FIG. 12 is a side view of the centrifuge rotor shown in FIG. 10.

FIG. 13 is a top view of yet another alternative embodiment of a centrifuge rotor;

FIG. 14 is a front view of the centrifuge rotor shown in FIG. 13.

FIG. 15 is a side view of the centrifuge rotor shown in FIG. 13.

FIG. 16 is a top view of still another alternative embodiment of a centrifuge rotor.

FIG. 17 is a front view of the centrifuge rotor shown in FIG. 16.

FIG. 18 is a side view of the centrifuge rotor shown in FIG. 16.

FIG. 19 is a top view of yet another alternative embodiment of a centrifuge rotor.

FIG. 20 is a front view of the centrifuge rotor shown in FIG. 19.

FIG. 21 is a side view of the centrifuge rotor shown in FIG. 19.

FIG. 22 is a photograph of four tubes containing separation gel after centrifugation using a 36 degree fixed angle rotor (left two tubes) and at 90 degrees using the centrifuge rotor according to embodiments of the present invention (right two tubes).

### DETAILED DESCRIPTION

Centrifuge rotors of the present disclosure provide separation of a sample using a compact, easy-to-use, portable centrifuge assembly. The presently disclosed centrifuge rotors (tube retainers) hold the sample tubes in a configuration within the centrifuge that occupies minimal space (e.g., width or diameter), thereby allowing for the overall centrifuge assembly to be compact in size.

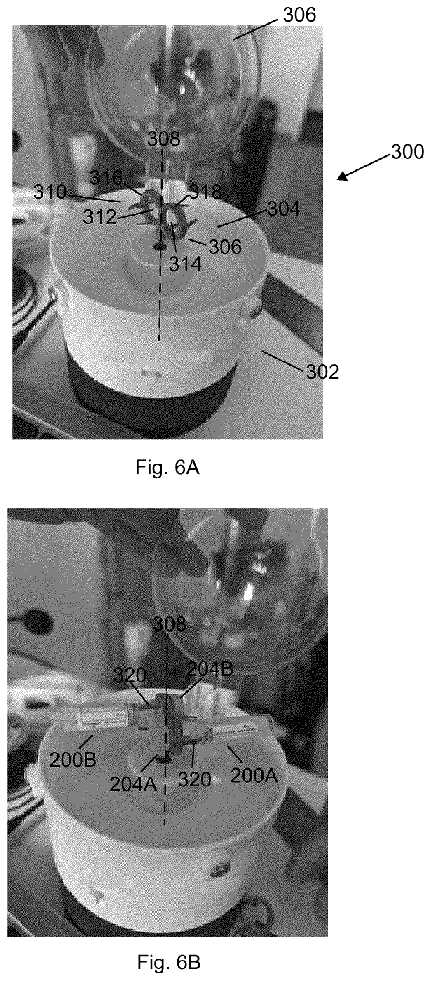

Collection of a blood sample to be analyzed that is collected at a remote location (i.e. not at a clinic) requires processing (separation) soon after it is collected. For example, the collected sample requires good separation using a centrifuge rotor that will effectively hold the sample tubes at an angle (e.g., 90 degrees) relative to a vertical rotational axis, wherein the centrifuge rotor is fabricated from a lightweight material and is minimized in size (e.g., width) such that the width of the centrifuge rotor when the samples tubes are inserted in the tube retainers is less than two times the length of a sample tube. Accordingly, the centrifuge rotor is minimized for size to hold at least two sample tubes, and the centrifuge rotor with the sample tubes therein are used in a small sized centrifuge. With an effective and minimized centrifuge rotor, samples tubes along with the centrifuge rotor can be easily transported (e.g., by U.S. mail or courier) to a subject at any location away from a clinic for blood collection and effective separation. Additionally, a kit for remote blood collection and separation, according to embodiments of the present invention, comprises at least two sample tubes and a centrifuge rotor as disclosed herein for holding the centrifuge rotor. In further embodiments, the kit comprises at least two sample tubes, a centrifuge rotor, and a minimized, lightweight centrifuge. A lightweight mini centrifuge according to the present disclosure includes, for example, the MC-700 from Abcbio™. A lightweight mini centrifuge for use with the centrifuge rotor according to embodiments of the present invention, may have a weight of about 0.10 kilogram (kg) to about 2.0 kg. The lighter weight allows for the centrifuge to be transported (e.g., mailed) with the centrifuge rotor. For example, the lightweight mini centrifuge may have a weight of about 0.10 kg to about 1.0 kg or about 0.20 kg to about 1.0 kg. In other exemplary embodiments, the weight of the centrifuge is about 0.20 kg up to about 0.80 kg. A centrifuge for use with the presently disclosed centrifuge rotors may have a speed up to 7000 rotations per minute (r/min). A suitable lightweight mini centrifuge is capable of sufficiently separating a sample using a centrifuge rotor as disclosed herein in FIGS. 6A-9.

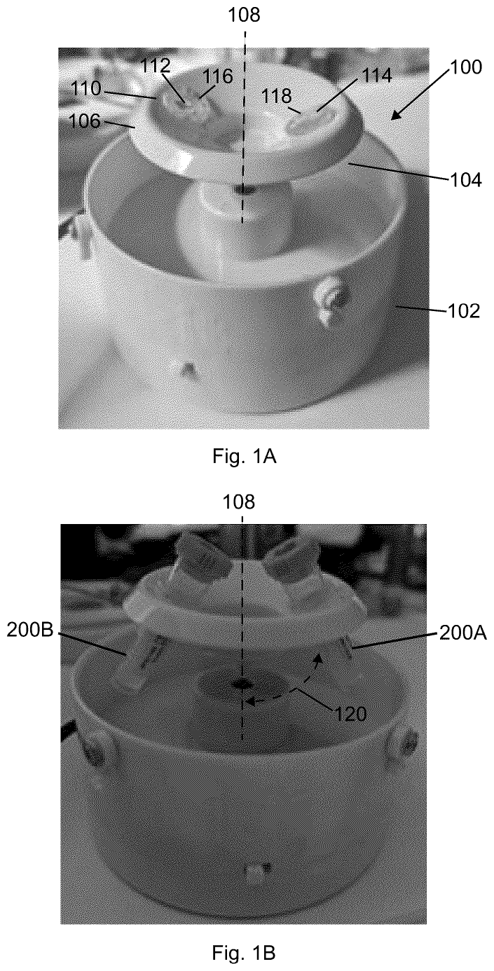

FIG. 1A and FIG. 1B depict an exemplary centrifuge with a fixed angle centrifuge rotor.

As shown in FIG. 1A, centrifuge 100 includes body 102 and centrifuge rotor 104. Body 102 contains electronics for operating centrifuge 100, including a motor and power source. In this example the power source is an integral battery, but an external power source can be used. In another alternative embodiment, the power source includes one or more removable batteries.

The motor includes a motor shaft that rotates centrifuge rotor 104 about a rotation axis 108 when the motor is operating. Centrifuge rotor 104 includes rotor body 106 and tube retainer 110. In the illustrated embodiment, the rotor body 106 is integral with the tube retainer 110. Alternatively, the rotor body may be a separate component that is fastened to the tube retainer. Rotor body 106 is perpendicular to rotation axis 108.

Tube retainer 110 includes first opening 112 and second opening 114 configured to hold a tube at angle 120 from rotation axis 108, as can be seen in FIG. 1B. In this example, the angle 120 is approximately 36 degrees. Angling at 36 degrees has several advantages including reducing the overall width of the centrifuge and improving aerodynamics. If the liquid separation is lopsided, however, such as in the case of blood gel separation, there is danger that the red blood cells can leak through the gel back into the serum, especially during transporting.

First retainer 116 is inserted into first opening 112. Second retainer 118 is inserted into second opening 114. First retainer 116 and second retainer 118 include a plurality of grips to secure a tube inserted into first opening 112 and second opening 114, respectively. The first and second retainers 116, 118 may be constructed of an elastomeric material. Tube 200A and tube 200B are inserted into first retainer 116 and second retainer 118 in the manner shown in FIG. 1B.

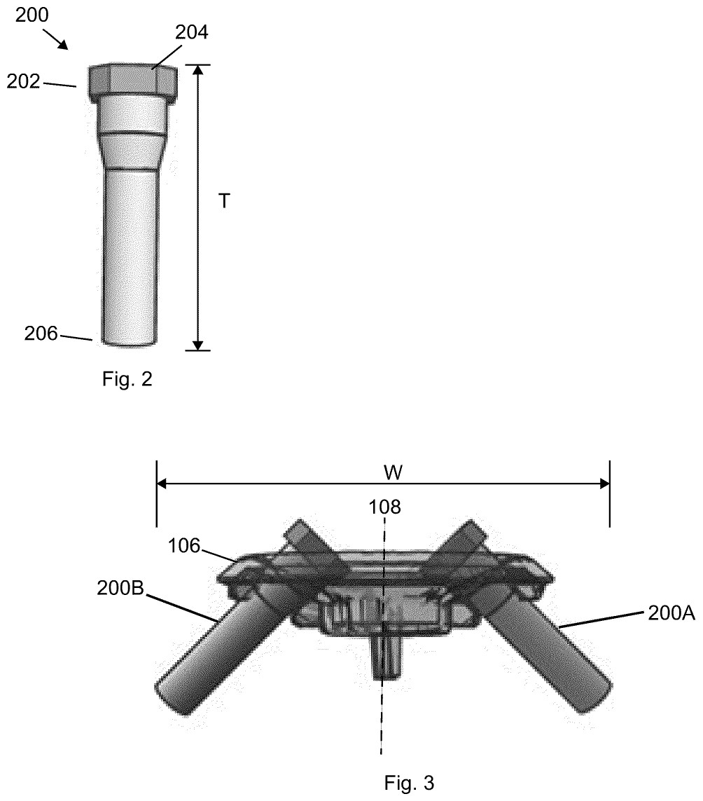

FIG. 2 is a side view of an exemplary tube 200 for inserting into a centrifuge rotor. Tube 200 comprises first end 202, tube head 204, and second end 206. In the illustrated embodiment, the tube 200 includes a large diameter portion adjacent to the tube head 204, a small diameter portion adjacent to the second end 206, and a transition portion that tapers from the large diameter portion to the small diameter portion. In other embodiments, the body of the tube has a single diameter.

In some embodiments, the openings of the tube retainer include a corresponding structure, to ensure that users insert the tube in the correct direction. Furthermore, the taper of the transition portion can assist users with properly securing the tube to the tub retainer by a friction fit, without the need for turning or twisting the tube.

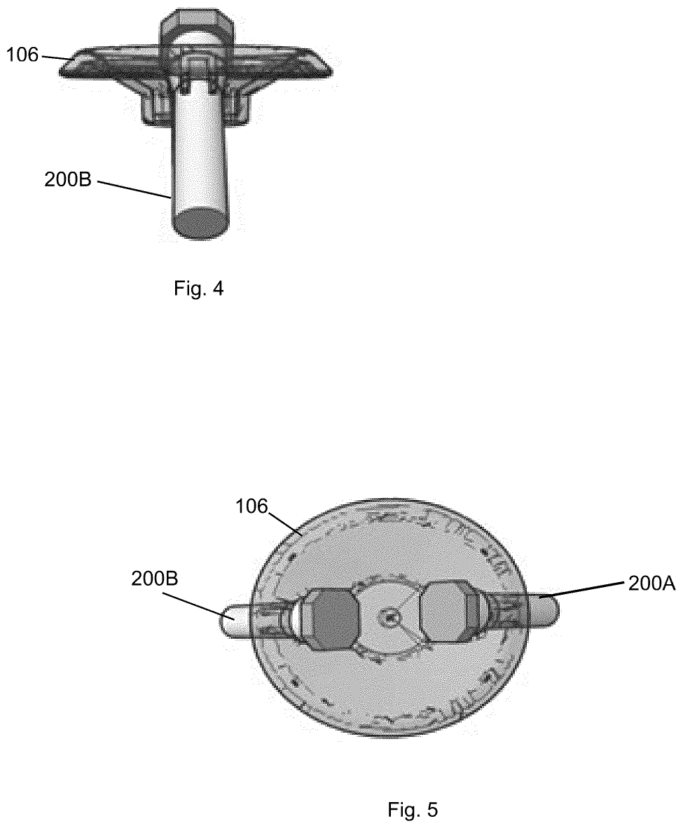

Tube 200 has a length T. As shown in FIG. 3, FIG. 4, and FIG. 5, the length T of tube 200 and arrangement of the plurality of tubes can contribute to the overall width W of a centrifuge rotor. It is advantageous to have a smaller overall width W, because it can reduce the spin time and weight of the centrifuge rotor, thereby significantly reducing the power to spin at given speeds. Minimizing power usage is especially relevant for battery-powered portable centrifuges where power is scarce. In addition, a reduced width W can result in cost savings related to shipping and packaging portable centrifuges.

Furthermore, the type and amount of material utilized to construct the centrifuge rotor can affect the overall weight. As shown in FIG. 4 and FIG. 5, rotor body 106 is a disc shape that includes unused surface area that can be removed to reduce the weight of the centrifuge rotor. For example, the material used to separate tube 200A and tube 200B from contacting, can be removed by arranging the tubes to be positioned side-by-side, as discussed below in further details.

FIG. 6A and FIG. 6B depict an exemplary compact centrifuge rotor arranged to minimize width, volume, and weight. Such a compact centrifuge may be particularly useful as a mobile centrifuge. For example, a compact centrifuge may be shipped as part of a home blood test kit. After the user takes a blood sample, the user may place one or more test tubes of blood in a compact centrifuge and then ship the assembly to a testing center. It should be understood, however, that the compact centrifuge is not limited to mobile applications.

According to embodiments of the present invention, a compact centrifuge rotor having two tube retainers 310 has a width in a range from about 2.0 cm to about 5.0 cm. For example, the width of the centrifuge rotor having two tube retainers has a width in a range from 2.0 cm to 4.5 cm, 2.0 cm to 4.0 cm, 2.0 cm to 3.5 cm, 2.0 cm to 3.0 cm, or 2.0 cm to 2.5 cm. The centrifuge rotor having two tube retainers may have a width in a range from 2.5 to 5.0 cm, 3.0 cm to 5.0 cm, 3.5 cm to 5.0 cm, 4.0 cm to 5.0 cm, or 4.5 cm to 5.0 cm. In other embodiments of the present invention, the width of the centrifuge rotor having two tube retainers has a width in a range from 2.5 cm to 3.5 cm, 2.6 cm to 3.4 cm, 2.7 cm to 3.3 cm, 2.8 cm to 3.2 cm, 2.8 cm to 3.1 cm, 2.8 cm to 3.0 cm, or 2.8 cm to 2.9 cm.

The centrifuge rotor 304 having two tube retainers 310, holds two or more sample tubes. For example, the centrifuge rotor 304 holds two sample tubes. The sample tubes have a length T of about 2.5 cm to 5.5 cm, 3.0 cm to 5.0 cm, 3.0 cm to 4.5 cm, 3.0 cm to 4.0 cm, or 3.0 cm to 3.5 cm. In other embodiments, sample tubes have a length T of about 3.5 cm to 5.5 cm, 4.0 to 5.5 cm, 4.5 cm to 5.5 cm, or 5.0 cm to 5.5 cm. In still other embodiments, the sample tubes have a length T of about 4.0 cm to 5.0 cm, 4.1 cm to 4.9 cm, 4.2 cm to 4.8 cm, 4.3 cm to 4.7 cm, 4.4 cm to 4.6 cm, or 4.4 cm to 4.5 cm.

As shown in FIG. 6A, centrifuge 300 comprises body 302, centrifuge rotor 304, and lid 306. Body 302 contains the electronics for operating centrifuge 300, including a motor and power source. Body 302 is substantially similar to body 102 shown in FIG. 1A. It should be understood, however that the diameter and length of the centrifuge body can be reduced as a result of the compact centrifuge rotor described in detail below. In this example the power source is an integral battery, but an external power source can be used. In exemplary embodiments of the present invention, the presently disclosed centrifuge rotor with sample tubes therein, can effectively separate a collected sample in one or both sample tubes using a centrifuge requiring 30 to 60 hertz (Hz) of power. In exemplary embodiments, a compatible and compact centrifuge for remote sample separation using the disclosed centrifuge rotor requires 45 to 55 Hz of power. In another alternative embodiment, a compatible centrifuge requires AC 220 volt. In other embodiments, the power source for a compatible and compact centrifuge for powering includes one or more removable batteries.

The motor comprises a motor shaft that rotates centrifuge rotor 304 about rotation axis 308 when the motor is operating. Centrifuge rotor 304 includes rotor body 306 and tube retainer 310. Rotor body 306 is perpendicular to rotation axis 308. Rotor body 106 and tube retainer 110 can be manufactured utilizing 3D printing, injection molding or CNC with materials, including but not limited to, plastic, light-weight metal, or wood-based materials. In exemplary embodiments, the centrifuge rotor is made of an elastomeric material (e.g., hard plastic, acrylonitrile butadiene styrene (ABS), or polylactic acid (PLA).

Tube retainer 310 comprises first opening 312 and second opening 314. Tube 200A and tube 200B are shown inserted into first retainer 316 and second retainer 318, respectively in FIG. 6B. Tube 200A and tube 200B are positioned side-by-side such that tube head 204A and tube head 204B overlap at rotation axis 308. Tube head 204A and tube head 204B face each other in the manner shown in FIG. 6A. Tube 200A and tube 200B are positioned substantially perpendicular to the rotation axis 308.

As can be seen in FIG. 6B, the overall width of centrifuge 300 is reduced compared to the overall width of centrifuge 100 shown in FIG. 1B. A tube angle of 90 degrees results in liquid separations that are flat instead of slanted in the tube. It has been found that such flat separation prevents the blood separation from leaking into the separated serum. It is estimated that the spin time of centrifuge rotor 304 is about 40% less than the spin time of centrifuge rotor 104 of FIGS. 1A and 1B and achieve similar blood separation.

In an alternative embodiment, the tube retainer may hold the tubes at an angle other than 90 degrees with respect to the axis of rotation. For example, the tube retainer may hold the tubes at an angle between 36 degrees to 90 degrees without departing from the broad principals disclosed herein. In exemplary embodiments, the tube retainers hold the tubes at a 90 degree angle.

In this example, the side-by-side positioning of the tubes allows for the material used for the first retainer and the second retainer to be reduced. First retainer 316 and second retainer 318 include at least one grip 320 and may include a plurality of grips 320. The grip(s) 320 is/are positioned at the second side of the first opening and second opening. For example, a plurality of grips 320 are positioned radially around first opening 312 and second opening 314 and taper inwards, thereby securing an inserted tube. Furthermore, the inward taper of the plurality of grips 320 assists in preventing users from inserting the tubes in the wrong direction. The length of the grips 320 may range from 0.2 cm to 1.2 cm, 0.3 cm to 1.1 cm, 0.4 cm to 1.0 cm, 0.5 cm to 1.0 cm, 0.4 cm to 1.0 cm, 0.5 cm to 1.0 cm, 0.6 cm to 1.0 cm. 0.7 cm to 1.0 cm, 0.8 cm to 1.0 cm, or 0.8 cm to 0.9 cm. In exemplary embodiments, the length of the grips range from 0.7 cm to 0.9 cm.

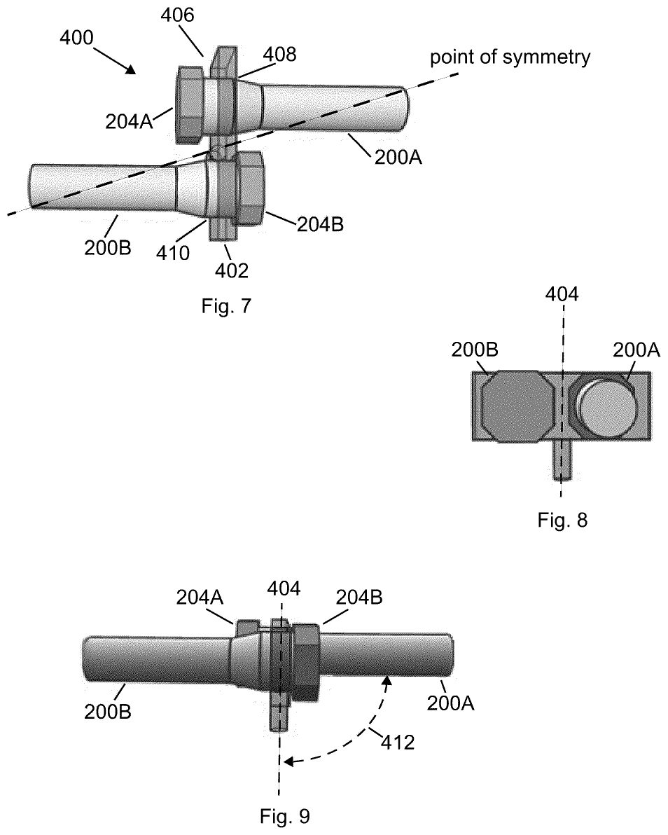

FIG. 7, FIG. 8, and FIG. 9 depict an exemplary centrifuge rotor configuration. wherein a plurality of tubes are aligned side-by-side and perpendicular to the rotation axis to reduce the overall width of a centrifuge rotor.

FIG. 7 is a top view of centrifuge rotor 400. Centrifuge rotor 400 includes rotor body 402, rotation axis 404, and tube retainer 406. Tube retainer 406 includes first opening 408 and second opening 410. Tube 200A and tube 200B are shown inserted into first opening 408 and second opening 410, respectively. As shown in FIG. 7 and FIG. 9, tube 200A and tube 200B are positioned side-by-side such that tube head 204A and tube head 2048 overlap at rotation axis 404. Furthermore, tube 200A and tube 200B are perpendicular to the rotation axis 404. As a result, the overall width W of centrifuge rotor 400 is less than two times the length T of tube 200. According to some embodiments, the overall width W of the centrifuge rotor with sample tubes therein is in a range from about 2.0 cm to about 8.0 cm. For example, the overall width includes 2.5 cm to 8.0 cm, 3.0 cm to 8.0 cm, 3.5 cm to 8.0 cm, 4.0 cm to 8.0 cm, 4.5 cm to 8.0 cm, 5.0 cm to 8.0 cm, 5.5 cm to 8.0 cm, 6.0 cm to 7.5 cm, or 6.5 cm to 7.5 cm. In addition, orienting the tubes in this manner results in liquid separations that are flat instead of slanted in the tube. Tube 200A and tube 200B are positioned coplanar in the manner shown in FIG. 8.

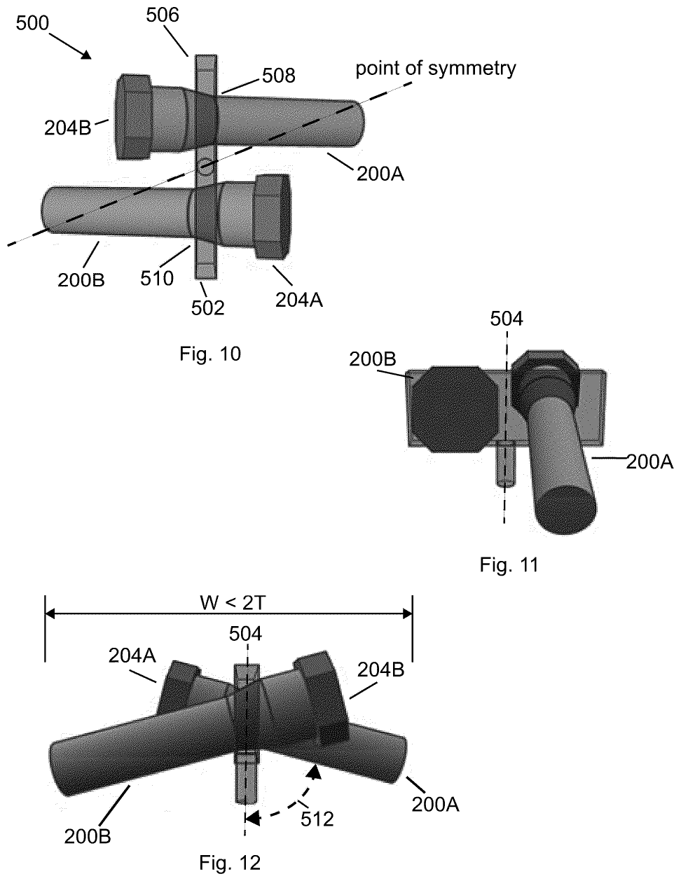

FIG. 10, FIG. 11, and FIG. 12 depict another exemplary centrifuge rotor configuration, wherein a pair of centrifuge tubes 200 are positioned to reduce the overall width W of a centrifuge rotor.

FIG. 10 is a top view of centrifuge rotor 500. Centrifuge rotor 500 includes rotor body 502, rotation axis 504, and tube retainer 506. In this example, tube retainer 506 comprises first angled opening 508 and second angled opening 510. Tube 200A and tube 200B are shown inserted into first angled opening 508 and second angled opening 510, respectively. As shown in FIG. 10 and FIG. 12, tube 200A and tube 2008 are positioned side-by-side such that tube head 204A and tube head 204B overlap at rotation axis 504. Furthermore, tube 200A and tube 200B are positioned at an angle 512 from rotation axis 504. Angle 512 can be a fixed angle between 45 degrees and 90 degrees. As a result, the overall width W of centrifuge rotor 500 is less than two times the length T of tube 200. Tube 200A and tube 200B are positioned on different planes in the manner shown in FIG. 8.

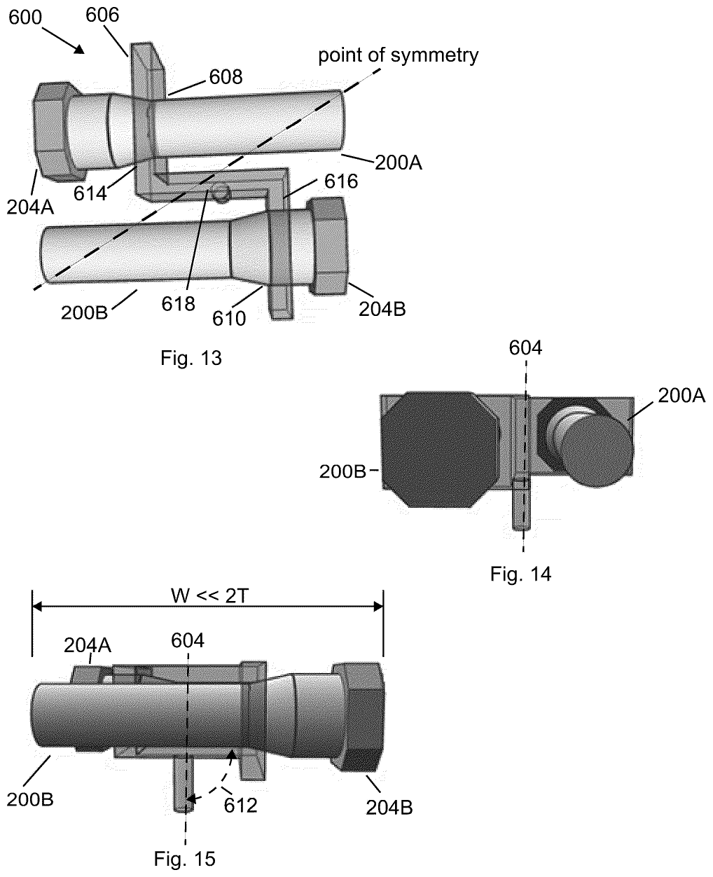

FIG. 13, FIG. 14, and FIG. 15 depict yet another exemplary centrifuge rotor configuration, wherein a plurality of centrifuge tubes 200 are positioned to further reduce the overall width of a centrifuge rotor.

FIG. 13 is a top view of centrifuge rotor 600. Centrifuge rotor 600 includes rotor body 602, rotation axis 604, and tube retainer 606. Rotor body 602 includes first arm 614, second arm 616, and central portion 618. In this example, first arm 614 and second arm 616 are perpendicular to central portion 618 in the manner shown in FIG. 13.

Tube retainer 606 comprises first opening 608 and second opening 610. Tube 200A and tube 200B are shown inserted into first opening 608 and second opening 610, respectively. As shown in FIG. 13 and FIG. 15, tube 200A and tube 2008 are positioned side-by-side such that tube head 204A and tube head 204B substantially overlap at rotation axis 604. Furthermore, tube 200A and tube 200B are positioned at angle 612 comprising 90 degrees from rotation axis 604. As a result, the overall width W of centrifuge rotor 400 is significantly less than two times the length T of tube 200. Tube 200A and tube 200B are positioned coplanar in the manner shown in FIG. 14.

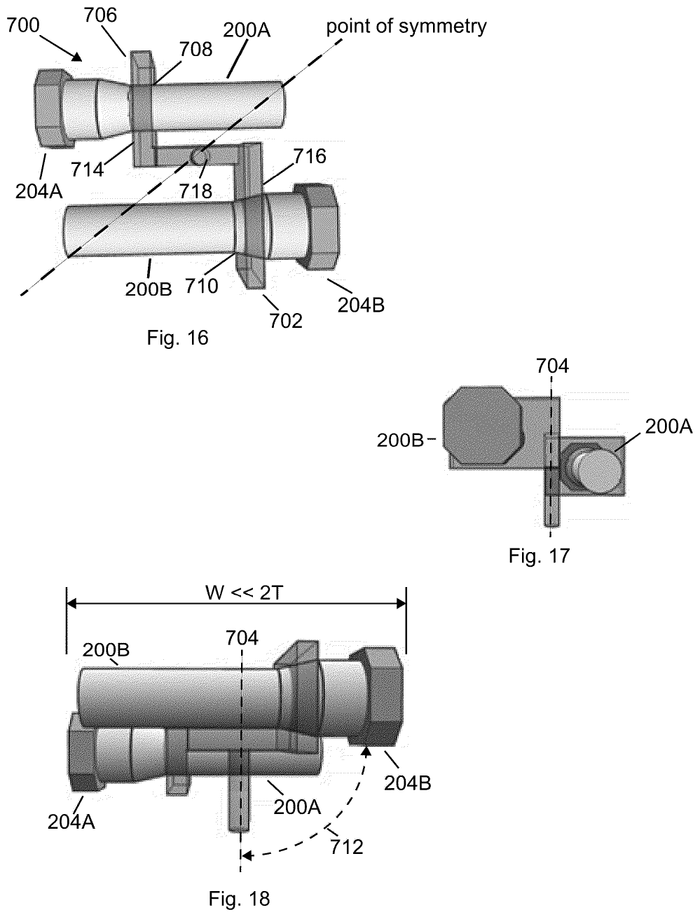

FIG. 16, FIG. 17, and FIG. 18 depict an exemplary centrifuge rotor configuration, wherein a plurality of centrifuge tubes 200 are positioned on different vertical planes.

FIG. 16 is a top view of centrifuge rotor 700. Centrifuge rotor 700 includes rotor body 702, rotation axis 704, and tube retainer 706. Rotor body 702 includes first arm 714, second arm 716, and central portion 718. In this example, first arm 714 and second arm 716 are perpendicular to central portion 718 in the manner shown in FIG. 16. First arm 714 defines a first horizontal plane and the second arm 716 defines a second horizontal plane above the first horizontal plane in the manner shown in FIG. 18.

Tube retainer 706 comprises first opening 708 and second opening 710. Tube 200A and tube 200B are shown inserted into first opening 708 and second opening 710, respectively. As shown in FIG. 16 and FIG. 18, tube 200A and tube 200B are positioned side-by-side such that tube 200A and tube 200B substantially overlap at rotation axis 704. Furthermore, tube 200A and tube 200B are perpendicular to the rotation axis 604. As a result, the overall width W of centrifuge rotor 700 is significantly less than two times the length T of tube 200. Tube 200A and tube 200B on different vertical planes in the manner shown in FIG. 14.

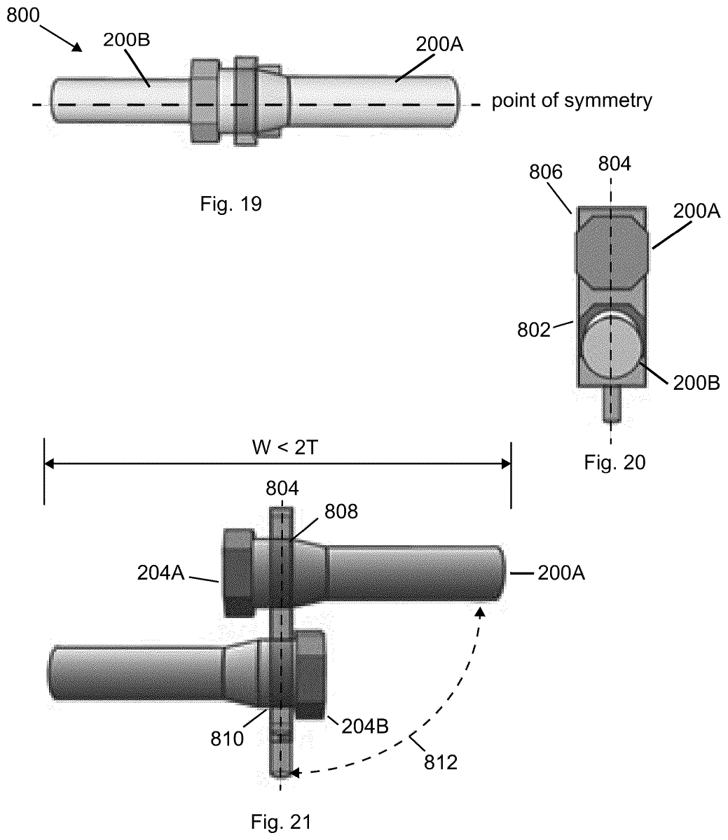

FIG. 19, FIG. 20, and FIG. 21 depict an exemplary centrifuge rotor configuration, wherein a plurality of centrifuge tubes 200 are positioned coplanar and stacked vertically.

FIG. 19 is a top view of centrifuge rotor 800. Centrifuge rotor 800 comprises rotor body 802, rotation axis 804, and tube retainer 806. In this example, tube retainer 806 comprises first opening 808 and second opening 810 stacked vertically. Tube 200A and tube 200B are shown inserted into first opening 808 and second opening 810, respectively. As shown in FIG. 19 and FIG. 20, tube 200A and tube 200B are positioned side-by-side such that tube head 204A and tube head 204B overlap at rotation axis 804. Furthermore, tube 200A and tube 200B are positioned at angle 812 comprising 90 degrees from rotation axis 804. As a result, the overall width W of centrifuge rotor 800 is less than two times the length T of tube 200. Tube 200A and tube 200B are positioned coplanar in the manner shown in FIG. 8.

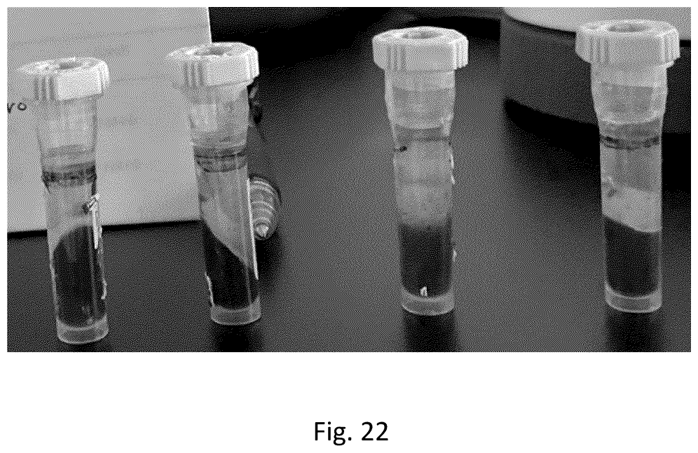

With reference to FIG. 22, the two tubes shown on the left were centrifuged using a fixed angled rotor at 36 degrees, and the two tubes shown on the right were centrifuged using a rotor (i.e., tube retainer) 310 as shown in FIGS. 6A and 6B at 90 degrees. The sample separation gels centrifuged in the 36 degree rotor have thin, uneven, and lopsided separation. (The two tubes on the left in FIG. 22.) Comparatively, the sample separation gels centrifuged in the tube retainer rotor 310 have even and straight separation. (The two tubes on the right in FIG. 22.) The thin, uneven, and lopsided separation from the 36 degree rotor is less separation than the separation of the tube retainer rotor 310.

Embodiments of the present invention also include kits comprising a centrifuge rotor as disclosed herein having two sample tube retainers and two sample tubes. The kit may be easily transported for delivery by vehicle and/or U.S. mail or courier for remote sample collection. The kit may also include a compact centrifuge for use after the collection of the blood sample. In an exemplary embodiment, a compact centrifuge for use with the disclosed centrifuge rotor includes the Mini Centrifuge. Model MC-700 manufactured by Ai Bi Sheng Biochemistry Technology.

As used in this specification and the appended claims, and unless otherwise specified, the terms “about” and “approximately,” when used in connection with various terms such as temperatures, doses, amounts, or weight percent of ingredients of a composition or a dosage form, mean e.g. a temperature, dose, amount, or weight percent that is recognized by those of ordinary skill in the art to provide an effect equivalent to that obtained from the specified temperature dose, amount, or weight percent. Specifically, the terms “about” and “approximately,” when used in this context, contemplate a temperature, dose, amount, or weight percent, etc. within 15%, within 10%, within 5%, within 4%, within 3%, within 2%, within 1%, or within 0.5% of the specified temperature, dose, amount, or weight percent, etc.

All publications and patent applications cited in this specification are herein incorporated by reference as if each individual publication or patent application were specifically and individually indicated to be incorporated by reference. While the claimed subject matter has been described in terms of various embodiments, the skilled artisan will appreciate that various modifications, substitutions, omissions, and changes may be made without departing from the spirit thereof. Accordingly, it is intended that the scope of the subject matter limited solely by the scope of the following claims, including equivalents thereof.

What is claimed is:

1. A centrifuge rotor for use in a compact centrifuge, the centrifuge rotor configured to rotate with respect to a rotation axis, the centrifuge rotor comprising:
a rotation axis; and
two or more tube retainers positioned opposite each other with the rotation axis therebetween;
wherein each of the two or more tube retainers capable of holding a tube,
wherein when two or more tubes are inserted into the two or more tube retainers, the
tube retainers with the tubes therein have an overall width which is less than two times the length of a tube.

2. The centrifuge rotor of claim 1, wherein the two or more tube retainers hold the two or more tubes at a 90 degree angle with respect to the rotation axis.

3. The centrifuge rotor of claim 1, wherein when the two or more tubes are inserted into the two or more tube retainers, the two or more tubes overlap at the rotation axis.

4. The centrifuge rotor of claim 1, wherein the two or more tube retainers comprise two tube retainers, and wherein the two tube retainers comprise:
a first arm comprising a first opening; and
a second arm comprising a second opening,
wherein a sample tube has a top end and a bottom end and the top end is defined by a cap which when in place, closes the sample tube to retain a sample therein.

5. The centrifuge rotor of claim 4, wherein each of the first opening and the second opening is configured to receive a first sample tube and a second sample tube, respectively, with the bottom end of the sample tube passing through the first opening or the second opening, followed by the length of the sample tube.

6. The centrifuge rotor of claim 5, wherein each of the first opening and the second opening comprises a first side and a second side and each of the openings comprises a direction, wherein the direction for each of the first opening and the second opening is defined from the first side of the opening through the opening to the second side from which the bottom end of the sample tube emerges.

7. The centrifuge rotor of claim 1, further comprising two sample tubes positioned in the tube retainers.

8. The centrifuge rotor of claim 1, wherein the overall width is in a range from about 2.0 cm to about 8.0 cm.

9. The centrifuge rotor of claim 1, wherein the overall width is in a range from about 5.0 to about 8.0 cm.

10. The centrifuge rotor of claim 1, wherein the two or more tube retainers are for holding sample tubes having a length from about 2.5 cm to about 5.5 cm.

11. The centrifuge rotor of claim 1, wherein the centrifuge rotor is fabricated from plastic, light-weight metal, and/or wood-based materials.

12. The centrifuge rotor of claim 1, wherein the centrifuge rotor is fabricated from an elastomeric material.

13. The centrifuge rotor of claim 6, further comprising at least one grip extending from the second side of the centrifuge opening.

14. The centrifuge rotor of claim 1, wherein the centrifuge rotor is compatible with a compact centrifuge having a power requirement of about 30 to about 60 hertz (Hz).

15. A kit for remote sample collection, the kit comprising the centrifuge rotor of claim 1 and at least two sample tubes.

16. The kit of claim 15, further comprising a compact centrifuge, having a weight of about 0.1 kg to 1.0 kg.

17. The kit of claim 15, wherein the compact centrifuge has a weight of about 0.1 kg to 1.0 kg.

18. A method of separating a collected blood sample, the method comprising:
placing a collected blood sample from a subject into a first sample tube;
placing the sample tube in the first tube retainer in the centrifuge rotor of claim 1;
balancing the first sample tube with a second sample tube having the same weight; and
centrifuging the first and second sample tubes in the centrifuge rotor using a compact centrifuge to separate the collected blood sample.

19. The method of claim 18, wherein the collected blood sample is collected from the subject at a remote location.

20. The method of claim 18, wherein the separated blood sample is transported or mailed for analysis.
